(19) United States
(12) Patent Application Publication
(10) Pub. No.: US 2015/0031220 A1
(43) Pub. Date: Jan. 29, 2015

(54) ELECTRICAL CONNECTOR WITH MAGNETIC ELEMENT

(71) Applicant: HON HAI PRECISION INDUSTRY CO., LTD., New Taipei (TW)

(72) Inventors: AI-HONG FANG, Kunshan (CN); HUO-XING JIN, Kunshan (CN); ZU-DE WANG, Kunshan (CN)

(21) Appl. No.: 14/341,844

(22) Filed: Jul. 28, 2014

(30) Foreign Application Priority Data
Jul. 26, 2013 (CN) 2013204492190

(51) Int. Cl. H01R 13/62

(52) U.S. Cl. CPC H01R 13/6205
USPC 439/38

(57) ABSTRACT

An electrical connector comprises an insulative housing loaded with a plurality of contacts and a magnetic element retained in the insulative housing. The insulative housing defines a mating face and an opposite mounting face. The magnetic element is located adjacent to the contacts. The contacts comprise middle contacting portion along the mating face and mounting portions at one end thereof extending to the mounting face.

### FIELD OF THE INVENTION

The present invention generally relates to an electrical connector with a magnetic element.

### DESCRIPTION OF RELATED ART

An electrical connector comprises an insulative housing loaded with several contacts and a pair of magnets. The contact is shaped as rectangular and defines a top face as a mating portion and a bottom face as a solder portion. However, the contacts are difficult to fix owing to its shape. Furthermore, the structure of the contact leads to a waste of more metal material.

In view of the foregoing, an electrical connector with a magnetic element is provided.

### SUMMARY OF THE INVENTION

Accordingly, an object of the present invention is to provide an electrical connector with a magnetic element.

In order to achieve the object set forth, an electrical connector comprises an insulative housing loaded with a plurality of contacts and a magnetic element retained in the insulative housing. The insulative housing defines a mating face and an opposite mounting face. The magnetic element is located adjacent to the contacts. The contacts comprise middle contacting portion along the mating face and mounting portions at one end thereof extending to the mounting face.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of ant electrical connector in accordance with the present invention;

FIG. 2 is another perspective view of the electrical connector shown in FIG. 1;

FIG. 3 is an exploded view of the electrical connector shown in FIG. 1; and

FIG. 4 is a cross-sectional view of the electrical connector shown in FIG. 1 taken along a line 4-4.

### DETAILED DESCRIPTION OF THE INVENTION

Reference will now be made in detail to the preferred embodiment of the present invention.

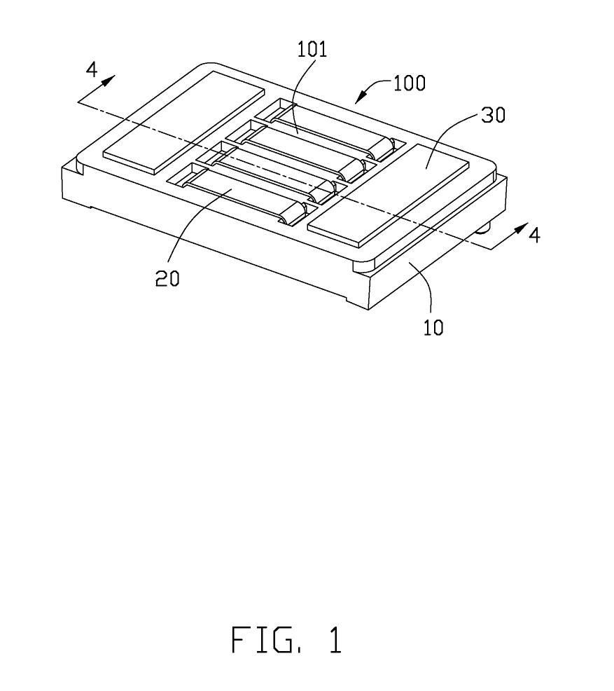

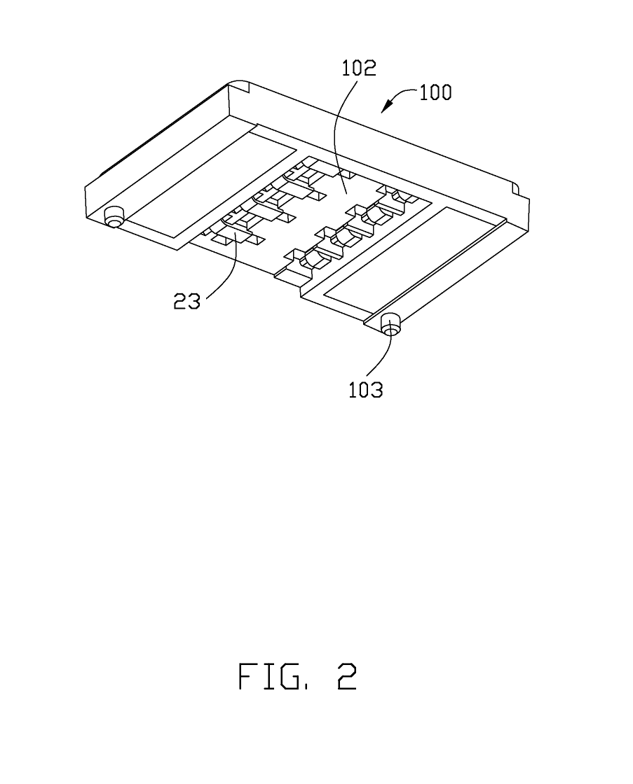

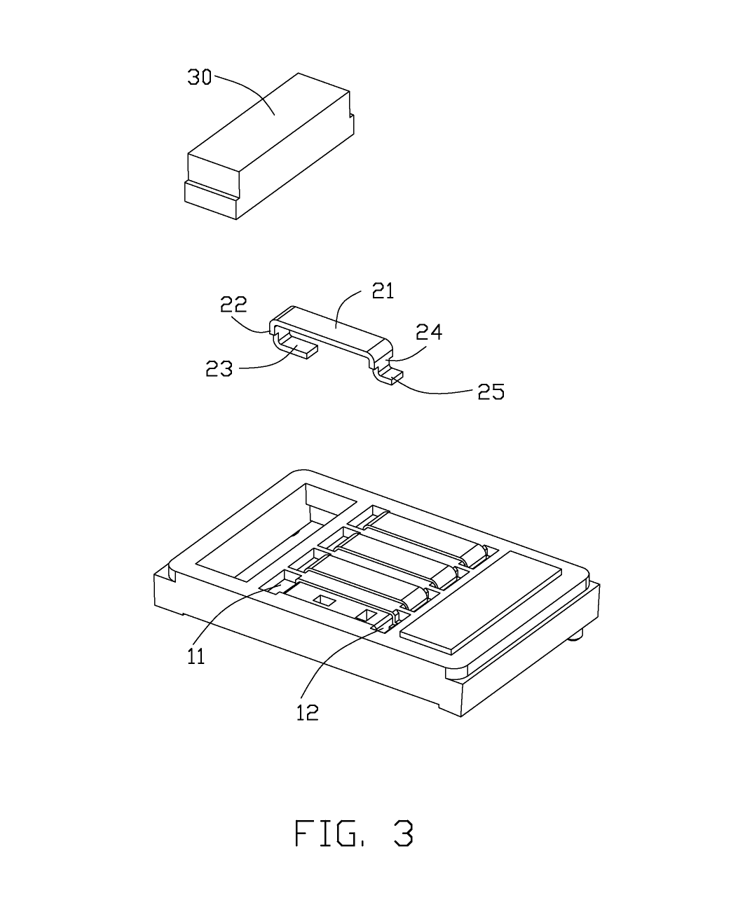

Referring to FIG. 1 to FIG. 4, an electrical connector 100 comprises an insulative housing 10, a plurality of contacts 20 retained on the insulative housing and a pair of magnetic elements 30 beside the contacts.

Referring to FIGS. 1-3, the insulative housing 10 is shaped as a rectangle and defines a mating face 101 at a top face and a mounting face 102 opposite to each other. The mating face 101 is intended to confront with a mating electrical connector (not shown) while the mounting face 102 is intended to confront with a printed circuit board (not shown, either). A pair of mounting posts 13 protrudes from the mounting face to be fixed to the printed circuit board. The insulative housing 10 also defines several first passageways 11 and second passageways 12 passing through both the mating face and mounting face.

The insulative housing 10 are injection molded with the contacts 20 and the magnetic elements 30. Each contact 20 comprises a contacting portion 21 exposed to the mating face 101, a first fixed portion 22 received in the first passageway 11, a mounting portion 23 exposed to the mounting face 102 and a second fixed portion received in the second passageway 12. The contact is formed from a metal sheet. The contacting portion 21 joints the first and second fixed portions and the first fixed portion joints the contacting portion 21 and the mounting portion 23. It is mentioned that the second passageways 12 is shorter than the first passageways 11 and apart from the mounting face 102. The second fixed portion 24 is also apart from the mounting face 102. The first and second fixed portions 22, 24 interfere with inner walls of the passageways 11, 12 so as to be retained on the insulative housing. The second fixed portion 24 comprises a vertical arm 24 perpendicular to the mating face 101 and a horizontal arm 25. A protruding portion 121 horizontally extends form the insulative housing and presses the vertical arm 24. The horizontal arm 25 is against to bottom face of the protruding portion 121 and not able to perk upward.

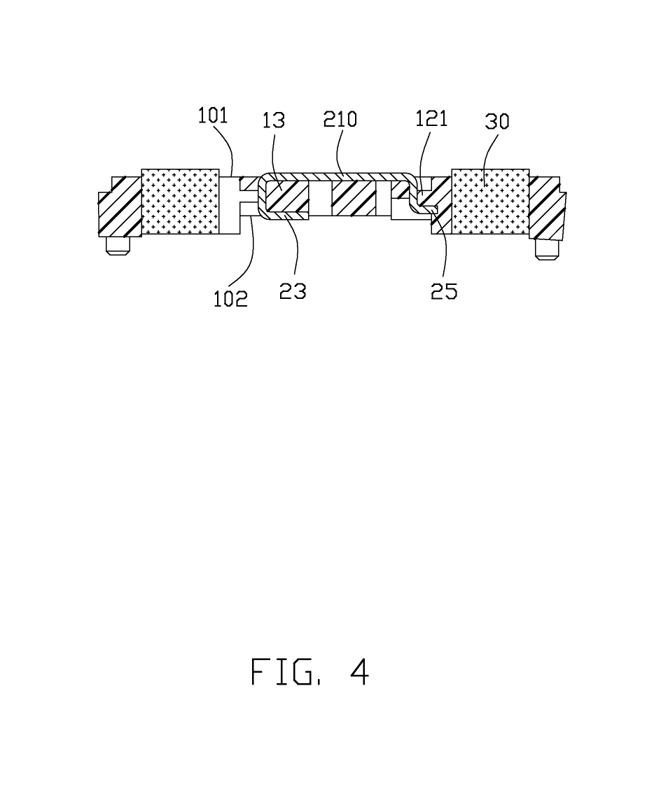

Combination with FIG. 1 and FIG. 4, the pair of magnetic elements 30 are located at opposite sides of the contacts 20 symmetrically. The magnetic elements 30 surround the contacts so as to provide enough electromagnetic force to attract the mating electrical connector when mated. The magnetic elements 30 are also exposed to the mating face 21. What's more, the top surface of each magnetic element 30 is higher than the contacting portions 21 so as to prevent the mating portions from directly collision by the mating electrical connector.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

We claim:

1. An electrical connector, comprising:
an insulative housing defining a mating face and an opposite mounting face;
a plurality of contacts retained on the insulative housing;
a magnetic element retained in the insulative housing and located adjacent to the contacts;
wherein the contacts comprise middle contacting portions along the mating face and mounting portions at one end thereof extending to the mounting face.

2. The electrical connector as claimed in claim 1, wherein the contacts further comprise first fixed portions jointing the contacting portions and the mounting portions.

3. The electrical connector as claimed in claim 2, wherein the contacts comprise second fixed portions at another ends thereof

4. The electrical connector as claimed in claim 1, wherein the electrical connector comprises a pair of magnetic elements symmetrically arranged in opposite sides of the contacts.

6. The electrical connector as claimed in claim 3, wherein the second fixed portions comprises a first arm perpendicular to the mating face and a second arm parallel to the mating face.

7. The electrical connector as claimed in claim 6, wherein the second arm is pressed downwardly by a protruding portion defined by the insulative housing.

8. An electrical connector comprising:
an insulative housing defining a mating plane;
a plurality of contacts arranged along a first direction of the housing, each contact comprising a contacting portion extending in a section direction perpendicular to the first direction and attached to the mating plane and a mounting portion;
a pair of magnetic elements located at two sides of the contacts along the second direction;
wherein the magnetic elements project upwards from the contacting portions of the contacts.

9. The electrical connector as claimed in claim 8, wherein the mounting portions expose to an opposite face to the mating plane.

10. An electrical connector comprising:
an insulative housing forming therein opposite first and second rows of passageways opposite to each other in a transverse direction, each of said first and second rows arranged in a lengthwise direction perpendicular to said transverse direction, each of said passageways extending through the housing in a vertical direction perpendicular to both said transverse direction and said lengthwise direction;
a plurality of contacts located between said opposite first and second rows of passageways in said transverse direction, respectively, each of said contacts including a contacting portion supportably exposed upon an upward mating face of the housing, a first tail section located at one end of said contacting portion in the transverse direction and extending through the corresponding passageways in the first row with a horizontal solder section exposed upon a mounting face of the housing opposite o the mating face so as to prevent an upward movement of said tail section relative to the housing, and a second tail section located at the other end of said contacting portion in the transverse direction and extending through the corresponding passageway in the second row with a horizontal solder section exposed upon the mounting face so as to prevent upward movement of said second tail section relative to the housing; and
a pair of magnetic elements located by two sides of the contacts in said transverse direction and exposed upon the mating face.

11. The electrical connector as claimed in claim 10, wherein both said first tail section and said second tail section are of an L shape in a same orientation.

12. The electrical connector as claimed in claim 10, wherein said contacts are insert-molded within the housing, and the housing forms a plurality of through holes in alignment with the contacting portion in the vertical direction.

13. The electrical connector as claimed in claim 12, wherein either the first tail section or the second tail section communicates with the through hole in the transverse direction.
